(19) United States
(12) Patent Application Publication
(10) Pub. No.: US 2020/0122123 A1
(43) Pub. Date: Apr. 23, 2020

(54) CORE-SHELL CATALYST AND OXYGEN REDUCTION METHOD

(71) Applicants: OSAKA UNIVERSITY, Osaka (JP); TANAKA KIKINZOKU KOGYO K.K., Tokyo (JP)

(72) Inventors: Koichi MATSUTANI, Kanagawa (JP); Takeshi KAIEDA, Kanagawa (JP); Yasushi MASAHIRO, Tokyo (JP); Wilson Agerico tan DIÑO, Osaka (JP); Bhume CHANTARAMOLEE, Osaka (JP); Ryo KISHIDA, Osaka (JP); Paulus Himawan LIM, Osaka (JP); Hiroshi NAKANISHI, Osaka (JP)

(21) Appl. No.: 16/477,815

(22) PCT Filed: Aug. 29, 2017
(86) PCT No.: PCT/JP2017/030982

§ 371 Date: Jul. 12, 2019

(30) Foreign Application Priority Data
Jan. 16, 2017 (JP) 2017-005449

(51) Int. Cl. B01J 23/50; B01J 23/42; B01J 35/08; B01J 35/00; C01B 13/02

(52) U.S. Cl. CPC B01J 23/50; B01J 23/42; C01B 13/024; B01J 35/008; B01J 35/0086; B01J 35/08

(57) ABSTRACT

Provided is a catalyst having a core-shell structure (which employs a core comprised of a highly electrochemically stable, relatively inexpensive material and thereby reduces the amount of platinum used, while providing a better cost/performance ratio in catalytic activity as compared to when platinum particles are used as a catalyst) for use in an oxygen reduction reaction (cathode reaction in a fuel cell), and to provide an oxygen reduction method using the catalyst. Provided is a core-shell catalyst for use for an oxygen reduction reaction, including: a core that is comprised of silver; and a shell layer that comprised of platinum, the shell layer being comprised of platinum atoms constituting a (111) plane of or a (001) plane of a face centered cubic lattice, in the shell layer, a nearest neighbor platinum-platinum interatomic distance falling within the range of from 2.81 \acute{Å} to 2.95 \acute{Å}.

### TECHNICAL FIELD

An embodiment of the present invention relates to a core-shell catalyst and an oxygen reduction method in which the core-shell catalyst is used.

### BACKGROUND ART

Conventionally, a highly active platinum material has been mainly used as an electrode catalyst of a fuel cell. Note, however, that, platinum, which is a rare metal and is expensive, is required to be used in a smaller amount.

In order that a smaller amount of platinum is used in an electrode catalyst of a fuel cell, a method is proposed in which a smaller amount of platinum is used by employing an electrode catalyst in which catalyst particles having a core-shell structure are supported on a support. The core-shell structure is a structure in which platinum, which is a highly active material, is used only in a surface (shell) of a catalyst particle and a material different from platinum is used in an inner part (core) of the catalyst particle which inner part does not contribute to a catalytic reaction.

For example, Patent Literature 1 provides a description about a core-shell catalyst whose core is made of at least one transition metal selected from the group consisting of nickel, copper, palladium, silver, ruthenium, and the like and whose shell is made of at least one transition metal selected from the group consisting of platinum, nickel, copper, and the like. The core-shell catalyst achieves high catalytic activity by reducing carbon monoxide poisoning.

### CITATION LIST

### Patent Literature

### [Patent Literature 1]

Japanese Patent Application Publication, Tokukai, No. 2013-163137 (Publication date: Aug. 22, 2013)

### SUMMARY OF INVENTION

### Technical Problem

Patent Literature 1 provides a description about, as a specific example, a core-shell catalyst whose core and shell are made of ruthenium and platinum, respectively, which are selected from the candidate substances listed above. Patent Literature 1 also discloses that the catalytic activity of the core-shell catalyst is high at (111) and (002) planes which constitute a cuboctahedron particle observed in an HAADF-STEM image.

Note, however, that this core-shell catalyst is provided to achieve high catalytic activity in a hydrogen oxidation reaction (which is the anode reaction in a fuel cell) by reducing carbon monoxide poisoning, and therefore has not taken into consideration the catalytic activity in an oxygen reduction reaction (which is the cathode reaction in a fuel cell).

Patent Literature 1 also provides a description about, as another specific example, a core-shell catalyst whose core is made of nickel and whose shell is made of platinum. Patent Literature 1 discloses that, in cases where the core-shell catalyst is used in an oxygen reduction reaction, the core-shell catalyst shows high catalytic activity as compared to a platinum nanoparticle catalyst. However, Patent Literature 1 fails to state specifically at which planes of the core-shell catalyst the reaction is active.

In addition, ruthenium and nickel have relatively low oxidation potentials (i.e., oxidation potentials have a large negative value), and therefore are electrochemically unstable. Therefore, a catalyst containing ruthenium and/or nickel has an issue in that, when the catalyst is used in harsh conditions (strongly acidic, high potential conditions) at the cathode of a fuel cell, the catalyst easily dissolves.

An embodiment of the present invention was made in view of the above issue, and an object thereof is to provide a catalyst having a core-shell structure (which employs a core comprised of a highly electrochemically stable, relatively inexpensive material and thereby reduces the amount of platinum used, while providing a better cost/performance ratio in catalytic activity as compared to when a platinum particle is used as a catalyst) for use in an oxygen reduction reaction which is the cathode reaction in a fuel cell, and to provide an oxygen reduction method using the catalyst.

### Solution to Problem

In order to attain the object, the inventors of the present invention carried out first-principles calculation in which Computational Material Design (CMD) (see Introduction to Computational Materials Design—From the Basics to Actual Applications—(edited by Hideaki KASAI et al., published by Osaka University Press on Oct. 20, 2005)) was used. As a result of diligent study, the inventors focused on silver and palladium as core materials and finally accomplished the present invention.

Specifically, a core-shell catalyst in accordance with an embodiment of the present invention is a core-shell catalyst for use for an oxygen reduction reaction, including: a core that contains silver; and a shell layer that contains platinum, the shell layer being comprised of a plurality of platinum atoms constituting a (111) plane of or a (001) plane of a face centered cubic lattice, in the shell layer, a nearest neighbor platinum-platinum interatomic distance falling within the range of from 2.81 \acute{Å} to 2.95 \acute{Å}.

Another core-shell catalyst in accordance with an embodiment of the present invention is a core-shell catalyst for use for an oxygen reduction reaction, including: a core that contains palladium; and a shell layer that contains platinum, the shell layer being comprised of a plurality of platinum atoms constituting a (111) plane of or a (001) plane of a face centered cubic lattice, in the shell layer, a nearest neighbor platinum-platinum interatomic distance falling within the range of from 2.783 \acute{Å} to 2.81 \acute{Å}.

### Advantageous Effects of Invention

A core-shell catalyst in accordance with one aspect of the present invention includes: a core that contains silver; and a shell layer that contains platinum, the shell layer being comprised of a plurality of platinum atoms constituting a (111) plane of or a (001) plane of a face centered cubic lattice, in the shell layer, a nearest neighbor platinum-platinum interatomic distance falling within the range of from 2.81 \acute{Å} to 2.95 \acute{Å}. Another core-shell catalyst in accordance with one aspect of the present invention includes: a core that contains palladium; and a shell layer that contains platinum, the shell layer being comprised of a plurality of platinum atoms constituting a (111) plane of or a (001) plane of a face centered cubic lattice, in the shell layer, a nearest neighbor platinum-platinum interatomic distance falling within the range of from 2.783 \acute{Å} to 2.81 \acute{Å}. This makes it possible to provide a catalyst which is such that, in an oxygen reduction reaction which is the cathode reaction in a fuel cell, an activation barrier is present only in a dissociative adsorption process in which oxygen molecules are dissociated and adsorbed in the form of oxygen atoms on a catalytic surface, and, after the dissociative adsorption process, no activation barriers are present in a process in which the oxygen atoms react with protons to form water and in a process in which the water desorbs from the catalytic surface. Such characteristics of the core-shell catalyst in accordance with one aspect of the present invention are the same level as those of a catalyst particle made of platinum alone. In addition, silver and palladium are more electrochemically stable than ruthenium and nickel and less expensive than platinum. Therefore, while ensuring the same level of activity of a catalytic surface as the catalyst particle made of platinum alone, it is possible to reduce the overall cost (material cost) of the catalyst. That is, a cost/performance ratio, which is an indicator of the magnitude of catalytic activity relative to the overall cost of the catalyst, improves. As such, it is possible to provide a catalyst having a core-shell structure (which employs a core comprised of a highly electrochemically stable, relatively inexpensive material and thereby reduces the amount of platinum used, while providing a better cost/performance ratio in catalytic activity as compared to when a platinum particle is used as a catalyst) for use in an oxygen reduction reaction (cathode reaction in a fuel cell), and to provide an oxygen reduction method using the catalyst.

### BRIEF DESCRIPTION OF DRAWINGS

FIG. 1 is a view illustrating a reaction model of the oxygen reduction reaction which reaction model includes a step of oxygen molecule dissociation.

FIG. 2 is a view illustrating a reaction model of the oxygen reduction reaction which reaction model includes a step of peroxyl dissociation.

FIG. 3 is a view illustrating a reaction model of the oxygen reduction reaction which reaction model includes a step of hydrogen peroxide dissociation.

FIG. 4 is a view of a (111) plane of an FCC structure as seen from a direction normal to the (111) plane.

FIG. 5 is a chart showing calculated values of adsorption energy with which an oxygen atom is adsorbed on adsorption sites of (111) planes of the FCC structures of the catalysts Pt, Pt_{ML}Ag, and Pt_{ML}Pd.

FIG. 6 illustrates adsorption sites of oxygen molecules at the (111) plane of Pt_{ML}Ag as seen from the direction normal to the (111) plane. (a) to (c) of FIG. 6 illustrate H—B—F, H-T-F, and F—NT-F sites, respectively.

FIG. 7 illustrates potential energy surfaces for adsorption reactions of oxygen molecules at the (111) plane of Pt_{ML}Ag. (a) to (c) of FIG. 7 illustrate potential energy surfaces for H—B—F, H-T-F, and F—NT-F sites, respectively.

FIG. 8 illustrates how relative positions between Pt and oxygen atoms change in a case where the dissociative adsorption reaction of oxygen molecules proceeds along pathway I shown in (a) of FIG. 7. (a) of FIG. 8 illustrates molecular adsorption state, (b) of FIG. 8 illustrates activated state, (c) of FIG. 8 illustrates dissociated state, and (d) of FIG. 8 illustrates stable state.

FIG. 9 illustrates how relative positions between Pt and oxygen atoms change in a case where the dissociative adsorption reaction of oxygen molecules proceeds along pathway J shown in (b) of FIG. 7. (a) of FIG. 9 illustrates molecular adsorption state, (b) of FIG. 9 illustrates activated state, and (c) of FIG. 9 illustrates dissociative adsorption state.

FIG. 10 illustrates how relative positions between Pt and oxygen atoms change in a case where the dissociative adsorption reaction proceeds from the state in which oxygen molecules are adsorbed in molecular form at F—NT-F sites (this state is shown in (c) of FIG. 6). (a) of FIG. 10 illustrates molecular adsorption state, (b) of FIG. 10 illustrates activated state, and (c) of FIG. 10 illustrates dissociative adsorption state.

FIG. 11 is a chart showing calculated values of adsorption energy, activation barrier, and distance between oxygen atoms, obtained when oxygen molecules adsorbed at H—B—F, H-T-F, and F—NT-F sites are dissociated and adsorbed in the form of oxygen atoms at the (111) plane of Pt_{ML}Ag.

FIG. 12 illustrates how a proton is donated by a hydronium ion to an oxygen atom adsorbed on a catalytic surface.

FIG. 13 is a chart showing calculated values of potential energy for an OH formation at the (111) plane of Pt_{ML}Ag.

FIG. 14 is a chart showing calculated values of potential energy for another OH formation that takes place on an oxygen atom present near the previously formed OH at the (111) plane of Pt_{ML}Ag.

FIG. 15 illustrates (111) planes of FCC structures as seen from a direction normal to the (111) plane, in each of which a plurality of OH groups have been formed on the catalytic surface. (a) to (c) of FIG. 15 illustrate the (111) planes of the catalysts Pt, Pt_{ML}Ag, and Pt_{ML}Pd, respectively.

FIG. 16 is a chart showing calculated values of potential energy for H₂O formation at the (111) planes of the catalysts Pt, Pt_{ML}Pd, and Pt_{ML}Ag.

FIG. 17 is a chart showing the magnitudes of activation barriers in the oxygen dissociation process, the OH formation process, and the H₂O formation process at the (111) planes of the catalysts Pt, Pt_{ML}Pd, and Pt_{ML}Ag.

(a) of FIG. 18 is a chart showing state densities at the surface (the (111) plane) of platinum. (b) of FIG. 18 is a chart showing state densities at the surface (the (111) plane) of Pt_{ML}Ag.

FIG. 19 illustrates the (001) plane of an FCC structure as seen from a direction normal to the (001) plane.

FIG. 20 is a chart showing changes of adsorption energy that occur when oxygen molecules adsorbed at the H-T-H, H—B—H, B—B, and T-B-T sites are dissociated and adsorbed in the form of oxygen atoms at the (001) plane of Pt_{ML}Ag.

FIG. 21 is a chart showing calculated values of potential energy for OH formation at the (001) plane of Pt_{ML}Ag.

FIG. 22 is a chart showing calculated values of potential energy for H₂O formation at the (001) planes of the catalysts Pt and Pt_{ML}Ag.

FIG. 23 is a chart showing the magnitudes of activation barriers in the oxygen dissociation process, the OH formation process, and the H₂O formation process at the (001) planes of the catalysts Pt, Pt_{ML}Ag, and Pt_{ML}Pd.

### DESCRIPTION OF EMBODIMENTS

The following description will discuss embodiments of the present invention in detail.

A core-shell catalyst whose core is comprised of silver or palladium and whose shell is comprised of platinum, in accordance with one embodiment of the present invention, is a catalyst that shows the same level of catalytic activity as that of a platinum catalyst particle in an oxygen reduction reaction which takes place at, for example, the cathode of a fuel cell, and that is capable of reducing the amount of platinum used. In the core-shell catalyst in accordance with one embodiment of the present invention, a (111) plane of or a (001) plane of a face centered cubic lattice is constituted by a plurality of platinum atoms that constitute a shell layer of the core-shell catalyst. In a case where the core is comprised of silver, the nearest neighbor platinum-platinum (Pt—Pt) interatomic distance in the shell layer is 2.81 \acute{Å} to 2.95 \acute{Å}, whereas, in a case where the core is comprised of palladium, the nearest neighbor Pt—Pt intermolecular distance in the shell layer is 2.783 \acute{Å} to 2.81 \acute{Å}.

As used herein, the “nearest neighbor Pt—Pt interatomic distance in a shell layer” may be the average of distances between nearest neighbor ones of the platinum atoms that are present in the shell layer. Such an average of the distances between nearest neighbor platinum atoms can be determined based on, for example, X-ray-absorption fine-structure (XAFS) spectroscopy.

A method of producing a core-shell catalyst in accordance with one embodiment of the present invention is not limited to a particular kind, and may be: a chemical means such as a liquid phase reduction method; or an electrochemical means such as an underpotential deposition method (UPD method).

For example, the liquid phase reduction method is a method by which a salt containing platinum that will constitute a shell is added to a solution having dispersed therein core particles made of silver or palladium or added to a solution having suspended therein supports that have the core particles supported thereon. The platinum ions in the solution are reduced with the use of a reducing agent such as hydrogen, sodium borohydride, or an alcohol, a platinum element is allowed to separate out on the core particles, and thereby a core-shell catalyst can be obtained.

For example, an electrochemical means is a means by which a salt containing platinum that will constitute a shell is added to a solution having dispersed therein core particles made of silver or palladium or added to a solution having suspended therein supports that have the core particles supported thereon. The rate at which platinum separates out on the surfaces of core nanoparticles is controlled by controlling reduction potential, and thereby a core-shell catalyst can be prepared.

The nearest neighbor Pt—Pt interatomic distance in the shell layer varies depending on the thickness of the platinum layer. According to the core-shell catalyst in accordance with one embodiment of the present invention, the nearest neighbor Pt—Pt interatomic distance falls within the aforementioned ranges, and thereby the core-shell catalyst shows the same level of catalytic activity as that of a platinum catalyst particle in an oxygen reduction reaction at a catalytic surface.

The following description will specifically discuss findings that the inventors made on their own during their study to accomplish the core-shell catalyst in accordance with one embodiment of the present invention, and also discuss effects provided by the core-shell catalyst.

In order to evaluate catalytic activity of a core-shell catalyst containing silver or palladium as a core material and containing platinum as a shell material, the inventors of the present invention carried out simulations in which first-principles calculation based on density functional theory was used. Note that the first-principles calculation is a calculation method based on the density functional theory showing that “ground-state energy of many-electron systems that interact with each other is determined in accordance with a density distribution of electrons” (see P. Hohenberg and W. Kohn, Phys. Rev. 136, B864 (1964), W. Kohn and L. J. Sham, Phys. Rev. 140, A1133 (1965), or Chapter 3 of “Kotai Denshi Kouzou [Solid-state Electronic Structure]” written by Takeo FUJIWARA, published by Asakura Publishing, Co., Ltd.). The first-principles calculation makes it possible to quantitatively discuss an electronic structure of a substance without an empirical parameter. Actually, the first-principles calculation allows effectiveness equivalent to that shown by experiments to be shown by many verifications. In the present simulations, a general density gradient approximation method, which is currently the most accurate one of the first-principles calculations, was used to carry out calculations.

In the present simulations, calculations were carried out with respect to not only a core-shell catalyst containing silver as a core material and containing platinum as a shell material (this catalyst is hereinafter referred to as “Pt_{ML}Ag”) and a core-shell catalyst containing palladium as a core material and containing platinum as a shell material (this catalyst is hereinafter referred to as “Pt_{ML}Pd”) but also, for comparison, a catalyst consisting solely of platinum (this catalyst is hereinafter referred to as “catalyst Pt”). The simulations were carried out under a condition that each of the catalysts was a catalyst constituted by six atomic layers, unless otherwise specified. Pt_{ML}Ag had a structure in which a single atomic layer of Pt was provided on five atomic layers of Ag, and Pt_{ML}Pd had a structure in which a single atomic layer of Pt was provided on five atomic layers of Pd. Note that a platinum layer, which is a shell layer, of a core-shell catalyst is not limited to a single atomic layer.

(1. Oxygen Reduction Reaction)

Prior to evaluation of catalytic activity, first, the following description discusses an oxygen reduction reaction, which is a cathode reaction of a fuel cell.

Known examples of a reaction model of the oxygen reduction reaction include the following three reaction models: a reaction model in which the oxygen reduction reaction proceeds through the step of (1) oxygen molecule dissociation (oxygen dissociation); a reaction model in which the oxygen reduction reaction proceeds through the step of (2) peroxyl dissociation; and a reaction model in which the oxygen reduction reaction proceeds through the step of (3) hydrogen peroxide dissociation.

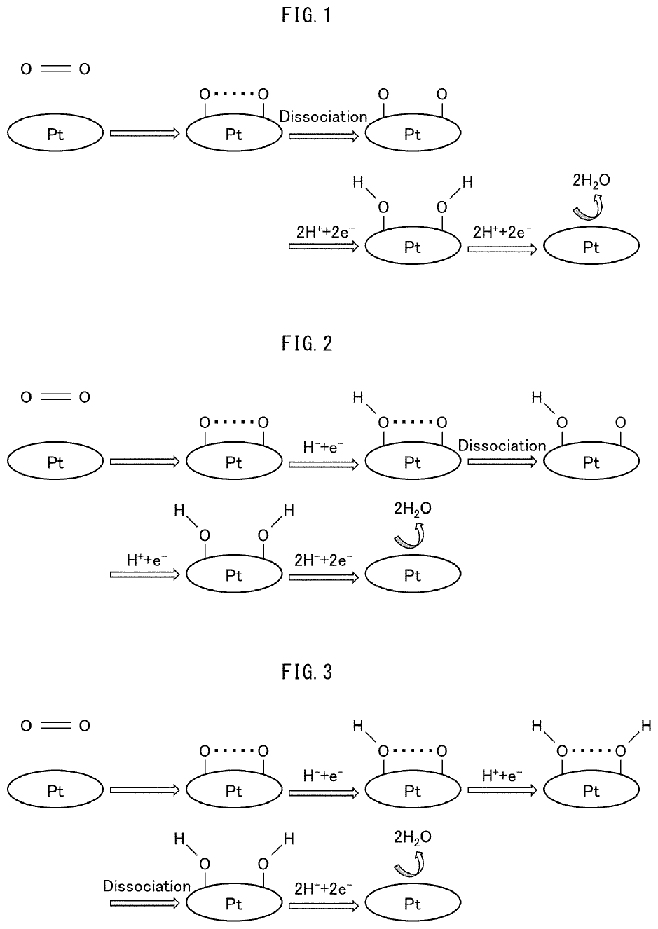

FIG. 1 is a view illustrating a reaction model of the oxygen reduction reaction which reaction model includes the step of oxygen molecule dissociation. As illustrated in FIG. 1, in the step of oxygen molecule dissociation, an oxygen molecule is adsorbed onto a catalytic surface first (O₂+*->O₂*). Note that the sign “*” means the catalytic surface, and O₂* means that the oxygen molecule is adsorbed on the catalytic surface. Next, the oxygen molecule which has been adsorbed on the catalytic surface is dissociated into oxygen atoms (O₂*+*->O*+O*). Then, a proton (H⁺) having been moved from the anode side through an electrolyte and an oxygen atom on the catalytic surface react with each other, so that OH is formed on the catalytic surface (O*+H⁺+e⁻->OH*). Finally, OH on the catalytic surface and a proton react with each other, so that water is generated and desorbed from the catalytic surface (OH*+H⁺+e⁻->H₂O).

FIG. 2 is a view illustrating a reaction model of the oxygen reduction reaction which reaction model includes the step of peroxyl dissociation. As illustrated in FIG. 2, also in the step of peroxyl dissociation, an oxygen molecule is adsorbed onto a catalytic surface first (O₂+*->O₂*) as in the case of the step of oxygen molecule dissociation. Next, a proton having been moved from the anode side through an electrolyte and the oxygen molecule on the catalytic surface react with each other, so that OOH is formed on the catalytic surface (O₂*+H⁺+e⁻->OOH*). Then, OOH is dissociated into an oxygen atom and OH (OOH*->O*+OH*). Subsequently, the oxygen atom on the catalytic surface and a proton react with each other, so that OH is formed (O*+H⁺+e⁻->OH*). Thereafter, OH on the catalytic surface and a proton react with each other, so that water is generated and desorbed from the catalytic surface (OH*+H⁺+e⁻->H₂O).

FIG. 3 is a view illustrating a reaction model of the oxygen reduction reaction which reaction model includes the step of hydrogen peroxide dissociation. As illustrated in FIG. 3, also in the step of hydrogen peroxide dissociation, an oxygen molecule is adsorbed onto a catalytic surface first (O₂+*->O₂*) as in the case of the step of oxygen molecule dissociation. Next, a proton having been moved from the anode side through an electrolyte and the oxygen molecule on the catalytic surface react with each other, so that OOH is formed (O₂*+H⁺+e⁻->OOH*). Subsequently, OOH on the catalytic surface and a proton react with each other, so that H₂O₂ is formed on the catalytic surface (OOH*+H⁺+e⁻->H₂O₂*). Thereafter, H₂O₂ on the catalytic surface is dissociated into two OH groups (H₂O₂*->OH*+OH*), and OH on the catalytic surface and a proton react with each other, so that water is generated and desorbed from the catalytic surface (OH*+H⁺+e⁻->H₂O).

As described above, an oxygen molecule is adsorbed onto a catalytic surface first in any of the reaction models of the oxygen reduction reaction which reaction models include the respective steps of oxygen molecule dissociation, peroxyl dissociation, and hydrogen peroxide dissociation, respectively.

Note here that silver, platinum, and palladium each have a face centered cubic (FCC) structure. A (110) plane of the FCC structure has a lower in-plane atom density than the other planes (e.g., a (111) plane and a (001) plane) of the FCC structure. Thus, oxygen molecule adsorption, which is a first stage of the oxygen reduction reaction, is considered to be more likely to occur in the (110) plane than in the other planes.

It has been reported that the levels of reaction activities at different planes of platinum satisfy the following relationship: (110) plane>(111) plane>(001) plane. On the other hand, the (110) plane has a greater surface energy than the other planes and is chemically unstable. The (110) plane is therefore known to be difficult to form on the surfaces of Pt particles as compared to the other planes.

The inventors conducted an investigation into an oxygen reduction reaction at each of the (110) planes of Pt_{ML}Ag and Pt_{ML}Pd, and made the following finding. Specifically, the inventors found that, under the conditions in which a fuel cell is being charged (voltage is being applied), the (110) plane of Pt_{ML}Ag shows a higher catalytic activity than the (110) plane of a catalyst made of platinum alone (catalyst Pt), and that the (110) plane of Pt_{ML}Pd shows a similar degree of catalytic activity to the (110) plane of the catalyst Pt.

Note, however that, it was also found that, at each of the (110) planes of the catalysts Pt, Pt_{ML}Ag, and Pt_{ML}Pd, when an electrode potential exists, there is an activation barrier in the final stage of the oxygen reduction reaction (i.e., in a process in which the produced water is desorbed from the catalytic surface), and that this process determines the rate of the reaction.

On the other hand, little is known about activation barriers in oxygen reduction reactions at the (111) and (001) planes of Pt_{ML}Ag and Pt_{ML}Pd. Since these planes can be dominantly present on core-shell catalyst particles, the inventors decided to study the magnitude of the activation barriers and the rate-determining process at the (111) and (001) planes.

The inventors therefore focused on the (111) plane and the (001) plane and carried out simulations as below.

(2. (111) Plane of FCC Structure)

(2.1. Adsorption of Oxygen Atom)

First, a case where an oxygen atom is adsorbed onto a catalytic surface is discussed before oxygen molecule adsorption, which is the first stage of the oxygen reduction reaction, is discussed.

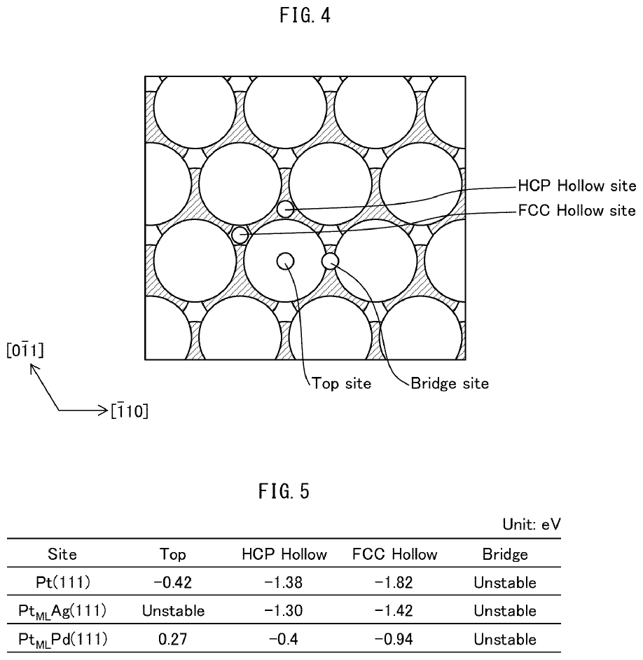

FIG. 4 is a view of a (111) plane of an FCC structure as seen from a direction normal to the (111) plane (the [111] direction). As illustrated in FIG. 4, in the case of a catalyst having, on a surface thereof, the (111) plane of the FCC structure, a total of four kinds of site, which are On-top (hereinafter, Top) site, Bridge (hereinafter, B) site, HCP Hollow (hereinafter, HH) site, and FCC Hollow (hereinafter FH) site, is assumed as adsorption sites of an oxygen atom.

Top site is an adsorption site that is present on top of an atom of a first layer of a catalytic surface. Note here that according to the (111) plane of the FCC structure, interatomic distances in a [−110] direction, which is an in-plane direction, and in a [0-11] direction, which is also an in-plane direction, are equal to each other. B site is an adsorption site that is present between atoms. Furthermore, at the (111) plane of the FCC structure, there are the following two kinds of adsorption site each present at a position surrounded by three atoms (such a position is referred to as Hollow): HH site, which is an adsorption site that is present at a Hollow positioned on top of an atom of a second layer beneath the first layer when seen from the [111] direction; and FH site, which is an adsorption site that is present at a Hollow that is positioned above a position (Hollow) surrounded by atoms of the second layer beneath the first layer when seen from the [111] direction.

In other words, HH site is, assuming that atoms are placed on the first layer to form an α-th layer such that the α-th layer, the first layer, and the second layer form a hexagonal closest packed (HCP) structure, an adsorption site that is present at a position where the atoms of the α-th layer are placed. FH site is, assuming that atoms are placed in the same manner as described above except that the a-th layer, the first layer, and the second layer form a face centered cubic (FCC) structure (FCC is such that layers are periodically repeated like ABCABC . . . in the [111] direction), an adsorption site at a position where the atoms of the α-th layer are placed. Note that the sign “-”, which is supposed to be given above a numeral indicative of a direction in writing in crystallography, is given before the numeral for convenience in writing, in this specification.

Assuming here that the difference (ΔE=E−E0) between energy (E0) with which an oxygen atom is present at an infinite distance from a catalytic surface and energy (E) with which the oxygen atom is adsorbed onto the catalytic surface is adsorption energy, the adsorption energy of the oxygen atom is found with respect to each kind of adsorption site.

FIG. 5 is a chart showing calculated values of adsorption energy with which an oxygen atom is adsorbed onto adsorption sites of the (111) planes of the FCC structures, in regard to each of the catalysts Pt, Pt_{ML}Ag, and Pt_{ML}Pd. In FIG. 5, “Unstable” indicates that the state of an oxygen atom adsorbed at an adsorption site is unstable. As shown in FIG. 5, the FH site of any of the catalysts Pt, Pt_{ML}Ag, and Pt_{ML}Pd has minimum adsorption energy. This reveals that, in a case where an oxygen atom is adsorbed on a catalytic surface (which here is the (111) plane of an FCC structure), the oxygen atom is more stably adsorbed at the FH site than at any other sites, in any of the cases of the catalysts Pt, Pt_{ML}Ag, and Pt_{ML}Pd.

(2.2. Adsorption of Oxygen Molecule)

Next, a case where an oxygen molecule is adsorbed onto a catalytic surface is discussed. According to a catalyst having, on a surface thereof, a (111) plane of an FCC structure, in the case where an oxygen molecule is adsorbed onto a catalytic surface, possible adsorption sites for oxygen molecules are Top site, B site, and NT site. The “NT site” stands for Near Top site, and is an adsorption site present near Top site. Note here that, for example, a state in which an oxygen molecule is adsorbed at a Top site means a state in which the center of gravity of the oxygen molecule is located at the Top site, i.e., means a state in which the midpoint of a line connecting the centers of gravity of two oxygen atoms is located at the Top site.

Assuming here that the difference (ΔE=E−E₀) between energy (E₀) with which an oxygen molecule is present at an infinite distance from a catalytic surface and energy (E) with which the oxygen molecule is adsorbed onto the catalytic surface is adsorption energy, the adsorption energy of the oxygen molecule is found with respect to each kind of adsorption site.

The following are the results of a simulation of an oxygen molecule adsorption reaction at the (111) plane of Pt_{ML}Ag.

It should be noted that, in regard to each kind of adsorption site, there would be a huge number of possible orientations of the oxygen molecule (three-dimensional orientation angle of the oxygen molecule); however, oxygen atoms in the following drawing are orientated in a way that was calculated to achieve minimum adsorption energy (i.e., adsorption is stable). The same applies to the subsequent drawings.

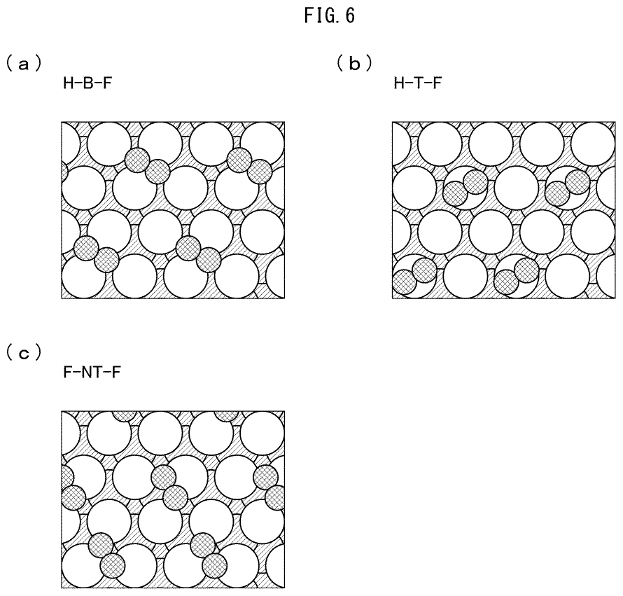

FIG. 6 illustrates adsorption sites of oxygen molecules at the (111) plane of Pt_{ML}Ag as seen from the direction normal to the (111) plane (i.e., [111] direction). (a) to (c) of FIG. 6 illustrate H—B—F, H-T-F, and F—NT-F sites, respectively. Note here that, for example, a state in which an oxygen molecule is adsorbed at an H—B—F site means a state in which the center of gravity of the oxygen molecule is located at a B site and two oxygen atoms are aligned on a line connecting an HH site, the B site, and an FH site. Similarly, a state in which an oxygen molecule is adsorbed at an H-T-F site means a state in which the center of gravity of the oxygen molecule is located at a Top site and two oxygen atoms are aligned on a line connecting an HH site, the Top site, and an FH site. A state in which an oxygen molecule is adsorbed at an F—NT-F site means a state in which the center of gravity of the oxygen molecule is located at an NT site and two oxygen atoms are aligned on a line connecting an FH site, the NT site, and another FH site.

In each of (a) to (c) of FIG. 6, the oxygen molecules reside at an adsorption height (the distance from an oxygen molecule to the catalytic surface) of about 4.5 \acute{Å}, and adsorption energy was about −0.07 eV. That is, these results indicate that the oxygen molecules are loosely adsorbed at positions slightly separated from the catalytic surface (such a state is referred to as molecular adsorption state).

A simulation was carried out to simulate how potential energy changes as an oxygen molecule in the above state approaches the catalytic surface and the oxygen molecule is dissociated and adsorbed in the form of oxygen atoms.

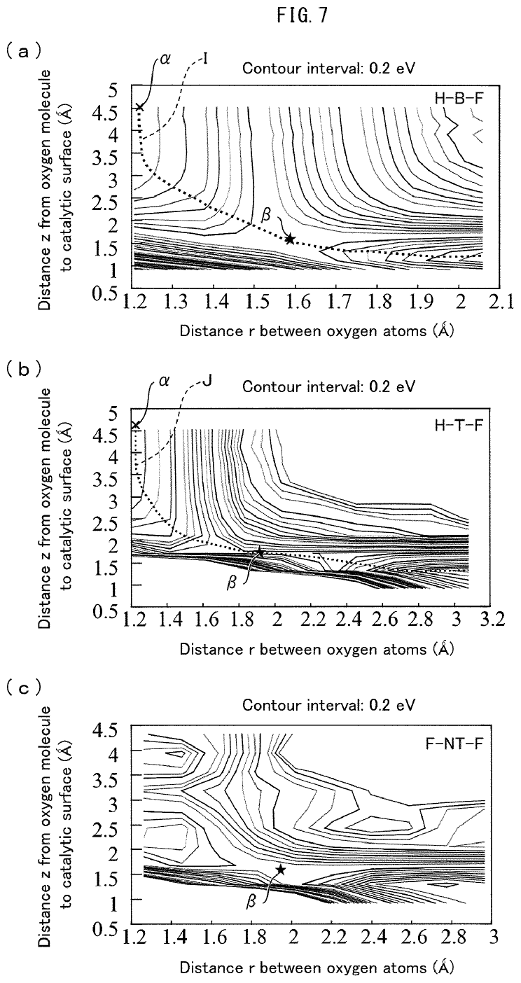

FIG. 7 shows potential energy surfaces for dissociative adsorption reactions of oxygen molecules at the (111) plane of Pt_{ML}Ag. (a) to (c) of FIG. 7 illustrate potential energy surfaces for H—B—F, H-T-F, and F—NT-F sites, respectively. In each of (a) to (c) of FIG. 7, the horizontal axis indicates distance r between oxygen atoms, and the vertical axis indicates distance z between an oxygen molecule and a catalytic surface. Contour lines of potential energy in FIG. 7 are drawn at intervals of 0.2 eV.

As illustrated in (a) of FIG. 7, it is inferred that, at the H—B—F site at the (111) plane of Pt_{ML}Ag, the dissociative adsorption reaction of an oxygen molecule proceeds along the pathway indicated by dotted line I shown in (a) of FIG. 7. Point α in (a) of FIG. 7 indicates the molecular adsorption state in which the oxygen molecule is adsorbed on the catalytic surface.

As the oxygen molecule in this molecular adsorption state (point α) is brought closer to the catalytic surface, the distance z decreases and the distance r increases. Then, after going through the state indicated by point β in (a) of FIG. 7, the distance r further increases, and this indicates that the oxygen molecule is dissociated and adsorbed in the form of oxygen atoms. Note here that the potential energy at point β is greater by 1.4 eV than that in the molecular adsorption state (point α), and this indicates that an activation barrier is present in the pathway represented by dotted line I.

As illustrated in (b) and (c) of FIG. 7, also at the H-T-F and F—NT-F sites of the (111) plane of Pt_{ML}Ag, the potential energy at point β is large. This indicates that activation barriers of 1.8 eV and 1.4 eV are present, respectively.

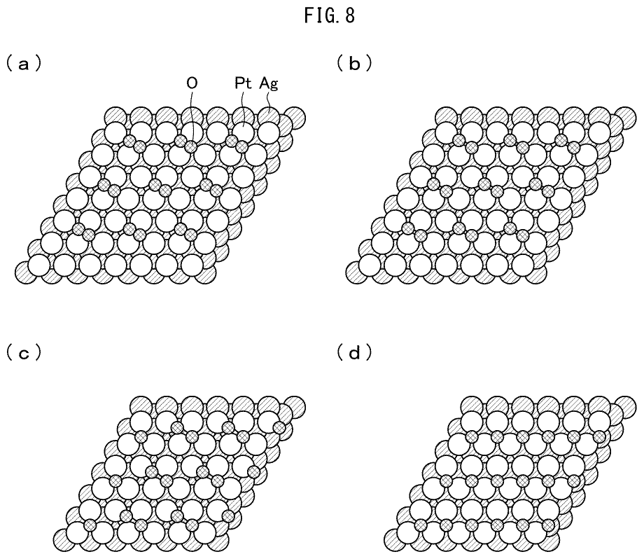

FIG. 8 illustrates how relative positions between Pt and oxygen atoms change in a case where the dissociative adsorption reaction of oxygen molecules proceeds along the pathway I shown in (a) of FIG. 7. (a) of FIG. 8 illustrates molecular adsorption state, (b) of FIG. 8 illustrates activated state, (c) of FIG. 8 illustrates dissociated state, and (d) of FIG. 8 illustrates stable state.

In (a) of FIG. 8, the oxygen molecules are adsorbed at positions about 4.5 \acute{Å} distant from the catalytic surface. In this case, the distance between oxygen atoms does not change. As illustrated in (b) of FIG. 8, when the oxygen molecules become closer to the catalytic surface, the distance between oxygen atoms slightly increases (activated state). Then, as illustrated in (c) of FIG. 8, the oxygen molecules dissociate into oxygen atoms, and these oxygen atoms are adsorbed at HH and FH sites. Here, a simulation was carried out while allowing structural relaxation of the adsorbed oxygen atoms. The results were such that, as illustrated in (d) of FIG. 8, the oxygen atoms moved from the HH sites to FH sites and were re-arranged. The arrangement of oxygen atoms, after such a re-arrangement, is the same as the dissociative adsorption in the case of F—NT-F sites (described later).

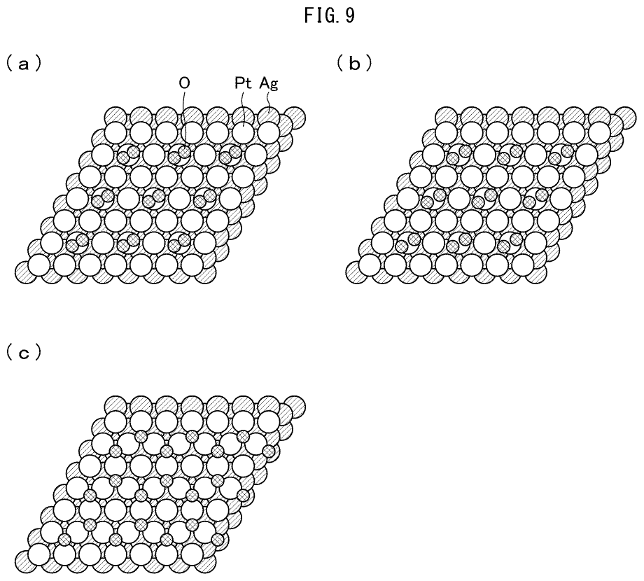

FIG. 9 illustrates how relative positions between Pt and oxygen atoms change in a case where the dissociative adsorption reaction of oxygen molecules proceeds along the pathway J shown in (b) of FIG. 7. (a) of FIG. 9 illustrates molecular adsorption state, (b) of FIG. 9 illustrates activated state, and (c) of FIG. 9 illustrates dissociative adsorption state.

(a) to (c) of FIG. 9 indicate that, as the oxygen molecules in the molecular adsorption state approach the catalytic surface, the oxygen molecules go through the activated state (in which the distance between oxygen atoms slightly increases), and then dissociate into oxygen atoms which are adsorbed at HH and FH sites. In this case, the re-arrangement of the adsorbed oxygen atoms did not occur even after the structural relaxation.

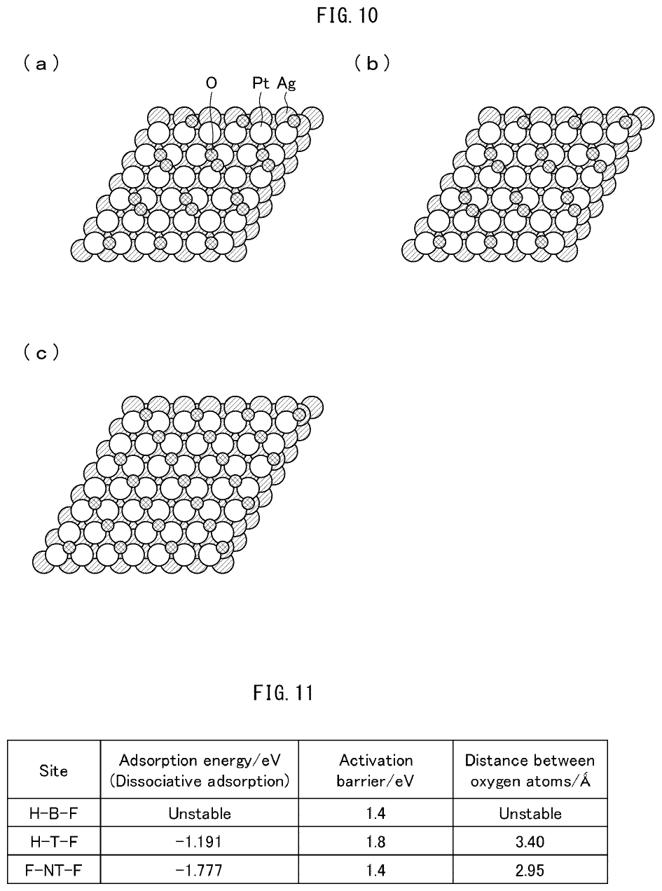

FIG. 10 illustrates how relative positions between Pt and oxygen atoms change in a case where the dissociative adsorption reaction proceeds from the state in which oxygen molecules are adsorbed in molecular form at F—NT-F sites (this state is shown in (c) of FIG. 7). (a) of FIG. 10 illustrates molecular adsorption state, (b) of FIG. 10 illustrates activated state, and (c) of FIG. 10 illustrates dissociative adsorption state.

(a) to (c) of FIG. 10 indicate that, as the oxygen molecules in the molecular adsorption state approach the catalytic surface, the oxygen molecules go through the activated state (in which the distance between oxygen atoms slightly increases), and then each of the oxygen molecules dissociates into oxygen atoms which are adsorbed at two FH sites.

FIG. 11 is a chart showing calculated values of adsorption energy, activation barrier, and distance between oxygen atoms, obtained when oxygen molecules adsorbed at H—B—F, H-T-F, and F—NT-F sites are dissociated and adsorbed in the form of oxygen atoms at the (111) plane of Pt_{ML}Ag. Note here that, when an oxygen molecule adsorbed in molecular form at an H—B—F site is subjected to dissociative adsorption, the dissociated oxygen atoms are re-arranged to reside at an F—NT-F site through structural relaxation; therefore, the adsorption energy for the H—B—F site in the chart is indicated as “Unstable”.

As shown in FIG. 11, the distance between oxygen atoms is 3.40 \acute{Å} in the case of the H-T-F site and is 2.95 \acute{Å} in the case of the F—NT-F site. FIG. 11 also indicates that the activation barrier is lower in the case of F—NT-F site than in the case of the H-T-F site, and that the absolute value of adsorption energy of oxygen atoms adsorbed in a dissociated state is greater in the case of the F—NT-F site than in the case of the H-T-F site. This indicates that, at the (111) plane of Pt_{ML}Ag, a reaction in which an oxygen molecule is dissociated and adsorbed in the form of oxygen atoms at two FH sites takes place relatively easily. The adsorption in the dissociated state at the F—NT-F site also includes a dissociative adsorption at an F—NT-F site which results from a transition from the H—B—F site through structural relaxation.

In the same manner as has been described, another simulation was carried out to simulate an oxygen molecule adsorption reaction at the (111) plane of Pt_{ML}Pd whose core contains palladium.

As a result, it was found that the activation barrier is smallest and the absolute value of adsorption energy is greatest in a case where, as oxygen molecules in the molecular adsorption state approach the catalytic surface, the oxygen molecules go through the activated state (in which the distance between oxygen atoms slightly increases) and then each of the oxygen molecules dissociates into oxygen atoms and adsorbed at two FH sites (adsorbed at an F—NT-F site). The value of the activation barrier was 1.2 eV, and the distance between oxygen atoms adsorbed at the two FH sites was 2.78 \acute{Å}.

(2.3. OH Formation)

It was found that, at each of the (111) planes of Pt_{ML}Ag and Pt_{ML}Pd, oxygen molecules adsorbed in molecular form on the catalytic surface is adsorbed loosely at a small distance from the catalytic surface, and that a state in which oxygen molecules have overcome the activation barrier and dissociated and adsorbed in the form of oxygen atoms on the catalytic surface is stable. In view of this, the following description discusses a formation of OH, which is a reaction that takes place after the dissociative adsorption in the dissociative adsorption step in the reaction model of oxygen reduction reaction.

As described earlier, the formation of OH, which is a reaction that takes place after the dissociative adsorption in the oxygen reduction reaction, takes place in the following manner: a proton (H⁺) traveled from the anode side through an electrolyte reacts with an oxygen atom at a catalytic surface to form OH at the catalytic surface (O*+H⁺+e⁻->OH*). The simulation here was carried out based on the assumption that a hydronium ion (H₃O⁺) donates a proton (H⁺) to an oxygen atom (O*) adsorbed on the catalytic surface and thereby OH forms on the catalytic surface (O*+H₃O⁺->OH*+H₂O).

The following are the results of the simulation of the OH formation reaction at the (111) plane of Pt_{ML}Ag.

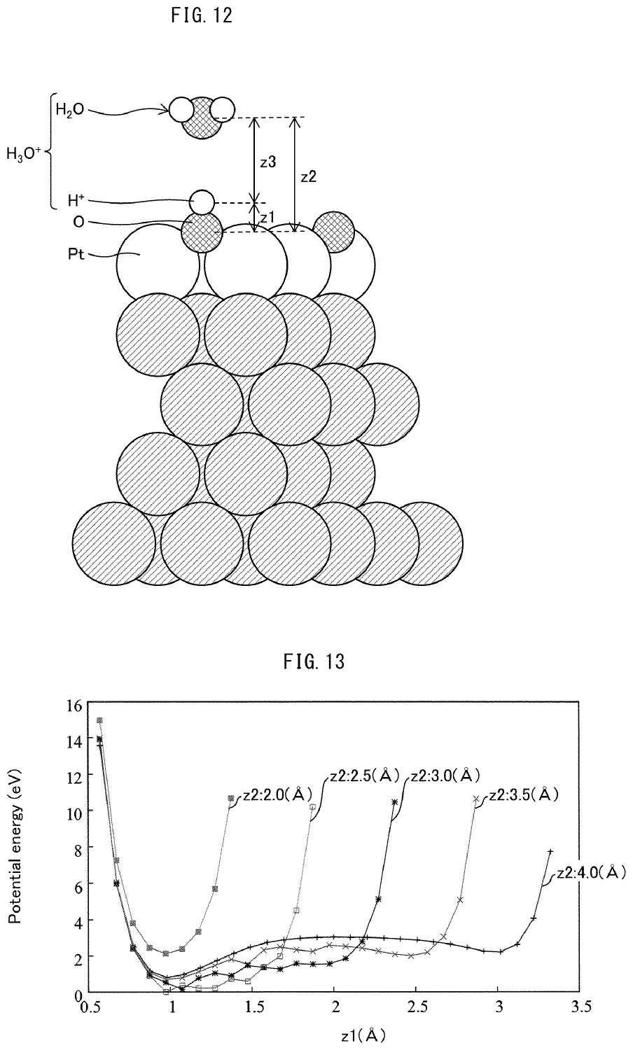

FIG. 12 illustrates how a proton is donated by a hydronium ion to an oxygen atom adsorbed on a catalytic surface.

The calculations were carried out based on the assumption that, as illustrated in FIG. 12, the oxygen atom is adsorbed at an FH site of the catalytic surface and the hydronium ion approaches the oxygen atom at the catalytic surface from directly above (in the direction normal to the (111) plane). The distance between the oxygen atom at the catalytic surface and the proton is referred to as distance z1, the distance between the oxygen atom at the catalytic surface and the oxygen atom contained in a water molecule is referred to as distance z2, and the distance between the proton and the oxygen atom contained in the water molecule is referred to as distance z3.

The simulations were carried out to simulate changes of potential energy for the OH formation by varying the distance z1 with the distance z2 unchanged.

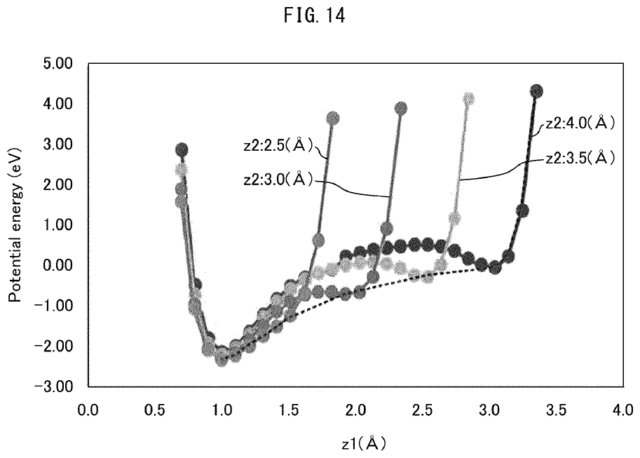

FIG. 13 is a chart showing calculated values of potential energy for an OH formation (first OH formation) at the (111) plane of Pt_{ML}Ag. FIG. 14 is a chart showing calculated values of potential energy for another OH formation (second OH formation) that takes place on an oxygen atom adsorbed in the dissociated state near the previously formed OH at the (111) plane of Pt_{ML}Ag. In FIGS. 13 and 14, the horizontal axis shows the distance z1 between the oxygen atom at the catalytic surface and the proton, whereas the vertical axis shows potential energy. The charts of FIGS. 13 and 14 show graphs for different values of the distance z2 between the oxygen atom at the catalytic surface and the oxygen atom contained in the water molecule.

In the process in which a proton is donated by a hydronium ion to an oxygen atom adsorbed on the catalytic surface, the hydronium ion approaches the oxygen atom adsorbed on the catalytic surface, and therefore the distance z3 decreases first. Next, the proton is donated by the hydronium ion to the oxygen atom adsorbed on the catalytic surface, the distance z1 decreases, and OH forms on the catalytic surface.

The focus here is placed on a graph for a distance z2 of 4.0 \acute{Å} in FIG. 13. The graph for a distance z2 of 4.0 \acute{Å} has a valley in potential energy change at the point at which the distance z1 is 3.0 \acute{Å}, where the potential energy is lower than those for other distances z1 around this point. A graph for a distance z2 of 3.5 \acute{Å} has a valley of potential energy change at the point at which the distance z1 is 2.5 \acute{Å}. These indicate that the hydronium ion is metastably present at the point at which the distance z3 is 1.0 \acute{Å} (the distance between the oxygen atom contained in the hydronium ion and the proton is 1.0 \acute{Å}).

Furthermore, the potential energy is lowest at the point at which the distance z1 is about 1.0 \acute{Å} in cases of all the distances z2. The value of the potential energy at the point at which the distance z1 is about 1.0 \acute{Å} becomes smaller as the distance z2 decreases from 4.0 \acute{Å} to 3.5 \acute{Å}, from 3.5 \acute{Å} to 3.0 \acute{Å}, and then from 3.0 \acute{Å} to 2.5 \acute{Å}. Note that, in the case where the distance z2 is 2.0 \acute{Å}, the hydronium ion is too close to the catalytic surface, and therefore the potential energy at the point at which the distance z1 is about 1.0 \acute{Å} is large; however, similarly to the cases of other distances z2, there is a valley of potential energy at the point at which the distance z1 is about 1.0 \acute{Å}.

As described above, in the process in which the distance z2 decreases and then the distance z1 decreases, the potential energy continues to decrease. This indicates that, at the (111) plane of Pt_{ML}Ag, there are no activation barriers in the reaction in which a proton is donated by a hydronium ion to an oxygen atom adsorbed on a catalytic surface and OH forms on the catalytic surface.

Next, under the condition in which the OH has been formed on the (111) plane of Pt_{ML}Ag, the potential energy for another OH formation that takes place on an oxygen atom adsorbed in the dissociated state near the above formed OH was calculated. The results are shown in FIG. 14. Also in FIG. 14, in the process in which the distance z2 decreases and then the distance z1 decreases, the potential energy continues to decrease. This indicates that, at the (111) plane of Pt_{ML}Ag, under the condition in which the OH has been formed, there are no activation barriers in the reaction in which a proton is donated by a hydronium ion to an oxygen atom adsorbed on the catalytic surface near the formed OH and another OH forms on the catalytic surface.

In the same manner as has been described, simulations were carried out to simulate OH formations at the (111) plane of Pt_{ML}Pd, and it was found that there are no activation barriers in the reaction in which OH forms on the catalytic surface.

(2.4. H₂O Formation/Desorption)

It was found that, at each of the (111) planes of Pt_{ML}Ag and Pt_{ML}Pd, two OH groups result from two dissociated oxygen atoms that have been dissociated and adsorbed without activation barriers. Next, the following description discusses a formation of H₂O, which is a reaction that takes place after the OH formation in the dissociative adsorption step in the reaction model of the oxygen reduction reaction. The formation of H₂O takes place as follows: OH at the catalytic surface and a proton react with each other to form H₂O (OH*+H⁺+e⁻->H₂O). Simulations were carried out based on the assumption that a proton is donated by a hydronium ion to OH on a catalytic surface and H₂O forms (OH*+H₃O⁺->H₂O*+H₂O).

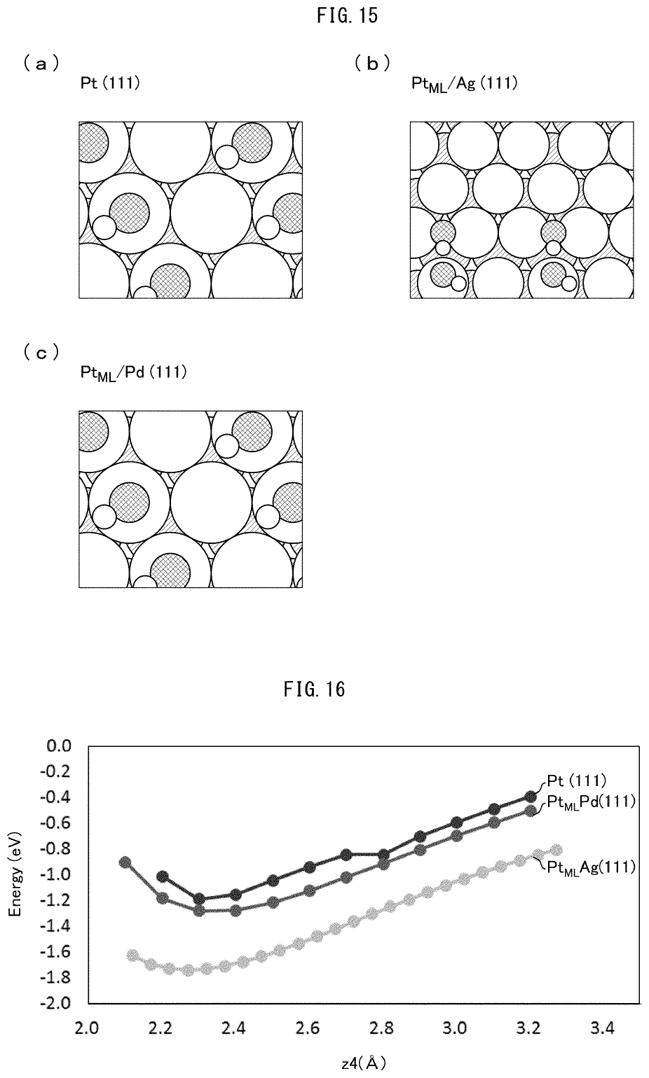

The simulations here were carried out on an adsorption site at which the OH, which has been formed on the catalytic surface, is stable. FIG. 15 illustrates (111) planes of FCC structures as seen from a direction normal to the (111) plane, in each of which OH has been formed on the catalytic surface. (a) to (c) of FIG. 15 illustrate the (111) planes of the catalysts Pt, Pt_{ML}Ag, and Pt_{ML}Pd, respectively.

(a) to (c) of FIG. 15 indicate that, at the (111) planes of the catalysts Pt, Pt_{ML}Ag, and Pt_{ML}Pd, the OH groups having been formed are stable when they are adsorbed at Top sites, at Top and B sites, and at Top sites, respectively. At the (111) planes of the catalysts Pt, Pt_{ML}Ag, and Pt_{ML}Pd, an adsorption site at which an oxygen atom is most stably adsorbed is FH site (see FIG. 5); therefore, it can be understood that, after the process in which a proton is donated by a hydronium ion to an oxygen atom adsorbed on the catalytic surface, the OH adsorbed on the catalytic surface undergoes structural relaxation and is moved (re-arranged). The calculations in the simulations here were carried out based on the assumption that, after the OH formation, the OH adsorbed on the catalytic surface moves; however, in actual reactions, the OH may move during the formation thereof (move concurrently with the OH formation).

The following are the results of simulations of the reaction in which a proton is donated by a hydronium ion to the OH adsorbed in the above-described manner on the catalytic surface and H₂O forms.

The calculations were carried out based on the assumption that the OH is adsorbed at each of the foregoing sites of the catalytic surface and that the hydronium ion approaches the OH at the catalytic surface from directly above (in the direction normal to the (111) plane). The distance between the oxygen atom of the OH at the catalytic surface and the oxygen atom contained in the hydronium ion is referred to as distance z4. The potential energy for the H₂O formation was calculated by varying the distance z4.

FIG. 16 is a chart showing calculated values of potential energy for H₂O formation at the (111) planes of the catalysts Pt, Pt_{ML}Pd, and Pt_{ML}Ag.

As shown in FIG. 16, in all the cases of the catalysts Pt, Pt_{ML}Pd, and Pt_{ML}Ag, the potential energy decreases as the hydronium ion is brought closer to the OH from far away from the catalytic surface and the distance z4 decreases. Furthermore, a structure optimization calculation based on a local minimum of the energy in FIG. 16 was carried out, and it was confirmed that the proton spontaneously moves to the OH at the catalytic surface. This indicates that, in the H₂O formation reaction at the (111) planes of the catalysts Pt, Pt_{ML}Pd, and Pt_{ML}Ag, the potential energy continues to decrease during the process in which the distance z4 decreases (the process in which the hydronium ion approaches OH), and that there are no activation barriers.

Furthermore, the potential energy for the state in which, at the (111) planes of Pt_{ML}Pd, and Pt_{ML}Ag, the produced H₂O is adsorbed on the catalytic surface was found, and adsorption energy was calculated. As a result, it was found that, at the (111) planes of Pt_{ML}Pd and Pt_{ML}Ag, also in the process in which the produced H₂O is desorbed from the catalytic surface, the activation barrier in the overall reaction is so small that it can be ignored.

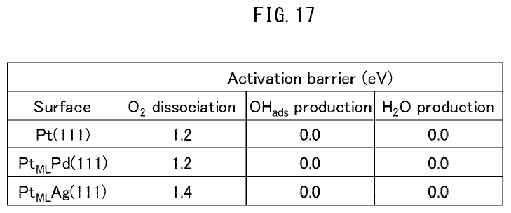

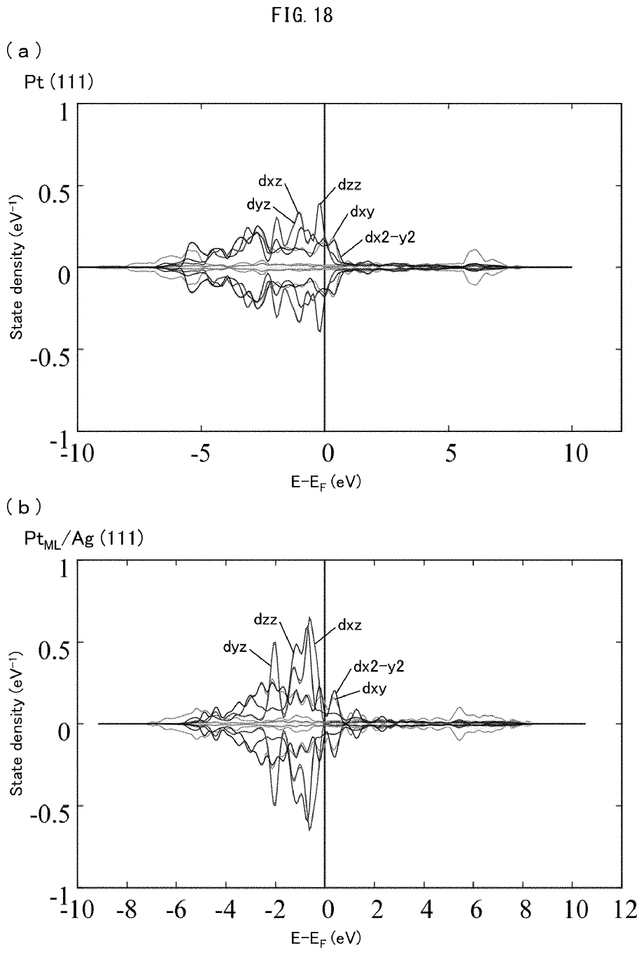

FIG. 17 is a chart showing the magnitudes of activation barriers in the oxygen dissociation process, the OH formation process, and the H₂O formation process at the (111) planes of the catalysts Pt, Pt_{ML}Pd, and Pt_{ML}Ag.

As shown in FIG. 17, in the process in which an oxygen molecule is dissociated and adsorbed in the form of oxygen atoms on a catalytic surface, the (111) planes of Pt_{ML}Pd and Pt_{ML}Ag have a similar degree of activation barrier to the (111) plane of the catalyst Pt. After the oxygen molecule is dissociated and adsorbed on the catalytic surface, at each of the (111) planes of the catalysts Pt, Pt_{ML}Pd, and Pt_{ML}Ag, the OH formation process and the H₂O formation process proceed without activation barriers. The OH formation process takes place at each of the dissociated oxygen atoms; therefore, the evaluations were carried out on the OH formation when only one of the oxygen atoms is protonated and on the second one of the OH formations when both oxygen atoms are protonated. As a result, it was confirmed that, in each of the OH formation processes, no activation barriers are present. Also in the process in which the produced H₂O is desorbed from the catalytic surface, the activation barrier in the overall reaction is so small that it can be ignored.

(2.5. Pt—Pt Interatomic Distance and State Density)

Incidentally, the following findings (i) and (ii) are known.

(i) It is reported by prior literatures that the strength of a bond between the surface of a substance and an oxygen atom is correlated with the lattice constant of the substance (see L. Grabow, Y. Xu, M. Mavrikakis, Phys. Chem. Chem. Phys. 8 (2006)3369., M. Mavrikakis, B. Hammer, J. K. Noerskov, Phys. Rev. Lett. 81 (1998) 2819., Y. Xu, A. V. Ruban, M. Mavrikakis, J. Am. Chem. Soc. 126 (2004) 4717.)

(ii) It is known that the strength of a bond between the surface of a substance and an oxygen atom is correlated with electron distribution (state density) at the surface of the substance. In particular, a theory called “d-band center theory” is famous. According to this theory, as the center of gravity of 5d orbitals (d-band center) of Pt becomes closer to the Fermi level, chemical adsorption of oxygen becomes stable, and therefore the bond between Pt and oxygen also becomes stronger (see A. Ruban, B. Hammer, P. Stoltze, H. L. Skriver, J. K. Noerskov, J. Mol. Catal. A: Chem. 115 (1997) 421.)

The inventors carried out a simulation of state density at the surface (the (111) plane of a face centered cubic lattice) of Pt_{ML}Ag in accordance with the present embodiment, by using first-principles calculation based on density functional theory. The results are shown in FIG. 18.

(a) of FIG. 18 is a chart showing state densities at the surface (the (111) plane of a face centered cubic lattice) of platinum. (b) of FIG. 18 is a chart showing state densities at Pt at the surface of Pt_{ML}Ag (the (111) plane of a face centered cubic lattice) of Pt_{ML}Ag. (a) and (b) of FIG. 18 each show the state density in one 5s orbital, three 5p orbitals, and five 5d orbitals. The “0” (zero) on the horizontal axis in (a) and (b) of FIG. 18 indicates the Fermi level. It should be noted here that, in (a) and (b) of FIG. 18, the state densities in the s and p orbitals are small; therefore, the notable five 5d orbitals (dxy, dyz, dzz, dxz, and dx2-y2) are shown with emphasis.

As shown in (a) of FIG. 18, the catalyst Pt has high electron densities at and near the Fermi level. This indicates that the catalyst Pt shows high catalytic activity.

As shown in (b) of FIG. 18, in Pt_{ML}Ag, the distribution of state densities in the 5d orbitals are generally concentrated around the Fermi level. Furthermore, a peak of the dxz orbital (which is important for O—Pt bond) near the Fermi level is closer to the Fermi level and is shaper. This indicates that Pt_{ML}Ag shows high catalytic activity and that the bond between the catalytic surface and oxygen is relatively strong (i.e., stable).

Similar calculation results were obtained also in regard to the state densities of Pt_{ML}Pd.

The inventors further carried out a simulation using first-principles calculation based on density functional theory in regard to the distance between nearest neighbor platinum atoms that include the (111) plane of a face centered cubic lattice of each core-shell particle (Pt_{ML}Ag and Pt_{ML}Pd) in accordance with the present embodiment.

The results of the calculation are as follows: the nearest neighbor Pt—Pt interatomic distance in a structure in which a single Pt atomic layer resides on Ag is 2.95 \acute{Å}; and the nearest neighbor Pt—Pt interatomic distance in a structure in which a single Pt atomic layer resides on Pd is 2.783 \acute{Å}.

Regarding the nearest neighbor Pt—Pt interatomic distance in the Pt layer serving as a shell layer on the surface of a core particle (Ag or Pd), the following holds: specifically, as the number of layers increases, the nearest neighbor Pt—Pt interatomic distance in a Pt layer becomes closer to the Pt—Pt interatomic distance in bulk Pt (for example, the interior of a bulk of Pt on the order of micrometer or greater). As a result of calculation using the first-principles calculation, the nearest neighbor Pt—Pt interatomic distance in bulk Pt is 2.81 \acute{Å}.

This indicates that, as more Pt layers are placed on Ag, the nearest neighbor Pt—Pt interatomic distance gradually decreases, and, on the contrary, as more Pt layers are placed on Pd, the nearest neighbor Pt—Pt interatomic distance gradually increases. In view of this, the nearest neighbor Pt—Pt interatomic distance in a shell layer (the (111) plane of a face centered cubic lattice) of Pt_{ML}Ag in accordance with the present embodiment is within the range of from 2.81 \acute{Å} to 2.95 \acute{Å}, whereas the nearest neighbor Pt—Pt interatomic distance in a shell layer (the (111) plane of a face centered cubic lattice) of Pt_{ML}Pd in accordance with the present embodiment is within the range of from 2.783 \acute{Å} to 2.81 \acute{Å}. Pt_{ML}Ag and Pt_{ML}Pd in accordance with the present embodiment each have a nearest neighbor Pt—Pt interatomic distance falling within the above range of calculated values, and thereby the bonding strength between oxygen atoms and Pt is optimized and no activation barriers appear in the H₂O formation/desorption reaction. If the ranges of the nearest neighbor Pt—Pt interatomic distances are narrower than the above ranges, the activation barrier in the adsorption reaction of oxygen molecules becomes higher, resulting in a decrease in oxygen reduction activity. On the contrary, if the ranges of the nearest neighbor Pt—Pt interatomic distances are wider than the above ranges, an activation barrier appears in the H₂O formation/desorption reaction, and it follows that a plurality of activation barriers are present in the oxygen reduction reaction. This results in a decrease in oxygen reduction activity.

According to the simulations carried out by the inventors, the nearest neighbor Pt—Pt interatomic distance was different from that of bulk Pt even in a case of a structure in which three Pt atomic layers were placed on Ag or Pd. It is therefore preferable that the shell layer (Pt layer) is constituted by one to three atomic layers.

(3. (001) Plane of FCC Structure)

Simulations similar to those which have been described were carried out in regard to the (001) plane of an FCC structure. The results are as follows.

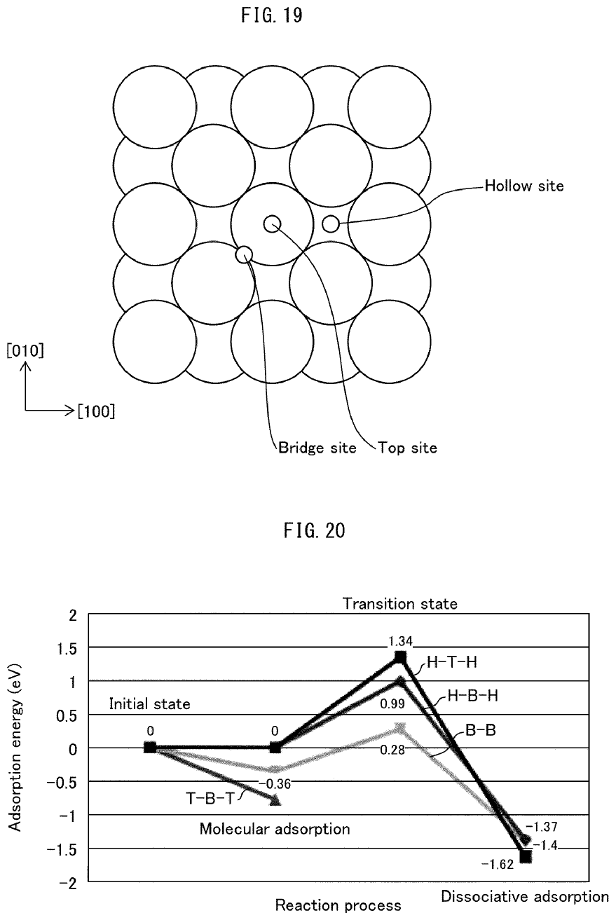

FIG. 19 illustrates the (001) plane of an FCC structure as seen from a direction normal to the (001) plane ([001] direction). As illustrated in FIG. 19, in a case of a catalyst that has the (001) plane of an FCC structure on its surface, there are three kinds of possible adsorption site for an oxygen atom: Top site; Bridge site; and Hollow site.

Top site is an adsorption site at the top of an atom of a first layer of a catalytic surface. Bridge site is an adsorption site between nearest neighbor atoms. Hollow site is an adsorption site surrounded by four atoms.

In the same manner as in the case of the (111) plane of the FCC structure, simulations were carried out, with respect to each of the adsorption sites at the (001) plane of Pt_{ML}Ag, to simulate (i) adsorption of oxygen molecules and (ii) changes of potential energy that occur when the oxygen molecules are brought closer to the catalytic surface and the oxygen molecules are dissociated and adsorbed in the form of oxygen atoms.

FIG. 20 is a chart showing changes of adsorption energy that occur when oxygen molecules adsorbed at the H-T-H, H—B—H, B—B, and T-B-T sites are dissociated and adsorbed in the form of oxygen atoms at the (001) plane of Pt_{ML}Ag. Note here that the simulations were carried out using, as a reference (0 eV), the energy in the initial state in which an oxygen molecule is present at an infinite distance from the catalytic surface. Further note that FIG. 20 shows the following states in the order from left to right: the initial state; the state in which the oxygen molecule is adsorbed in molecular form on the catalytic surface; the activated state; and the state in which the oxygen molecule is dissociated and adsorbed in the form of oxygen atoms on the catalytic surface.

The results in FIG. 20 indicate that, at the (001) plane of Pt_{ML}Ag, in the case of B—B site, the value of an activation barrier in the activated state is 0.28 eV, and the adsorption energy of oxygen atoms is as great as −1.4 V. That is, it was found that, at the (001) plane of Pt_{ML}Ag, the activation barrier is smallest and the absolute value of adsorption energy is greatest in a case where, as the oxygen molecule in the molecular adsorption state approaches the catalytic surface, the oxygen molecule goes through the activated state (in which the distance between oxygen atoms slightly increases), and then each of the oxygen molecules dissociates into oxygen atoms and adsorbed at two Bridge sites (adsorbed at a B—B site).

Next, the results of a simulation of an OH formation reaction at the (001) plane of Pt_{ML}Ag are provided below.

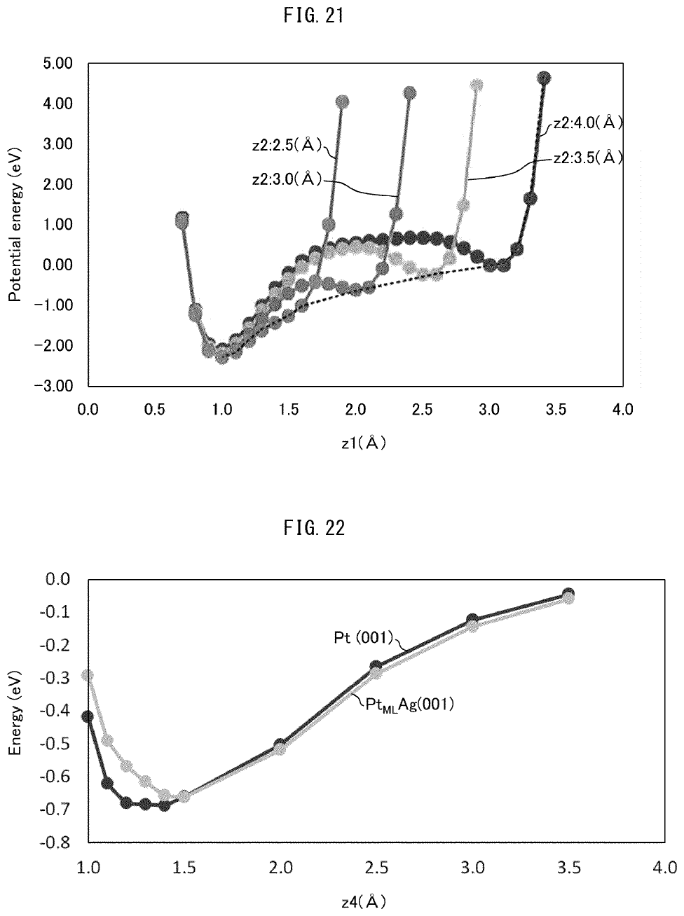

FIG. 21 is a chart showing calculated values of potential energy for OH formation at the (001) plane of Pt_{ML}Ag.

The calculations were carried out under the same conditions as described earlier with reference to FIG. 12, except based on the assumption that an oxygen atom is adsorbed at a Bridge site of a catalytic surface and that a hydronium ion approaches the oxygen atom on the catalytic surface from right above (in a direction normal to the (001) plane).

As shown in FIG. 21, in the process in which the distance z2 decreases and then the distance z1 decreases, the potential energy continues to decrease. This indicates that, at the (001) plane of Pt_{ML}Ag, there are no activation barriers in the reaction in which a proton is donated by a hydronium ion to an oxygen atom adsorbed on a catalytic surface and OH forms on the catalytic surface.

Next, the results of a simulation of an H₂O formation reaction at the (001) plane of Pt_{ML}Ag are provided below.

FIG. 22 is a chart showing calculated values of potential energy for H₂O formation at the (001) planes of the catalysts Pt and Pt_{ML}Ag.

As shown in FIG. 22, in the cases of both the catalysts Pt and Pt_{ML}Ag, the potential energy decreases as the hydronium ion is brought closer to the OH from far away from the catalytic surface and the distance z4 decreases. Furthermore, a structure optimization calculation based on a local minimum of the energy in FIG. 22 was carried out, and it was confirmed that the proton spontaneously moves to the OH at the catalytic surface. This indicates that, in the H₂O formation reaction at the (001) planes of the catalysts Pt and Pt_{ML}Ag, the potential energy continues to decrease in the process in which the distance z4 decreases (the process in which the hydronium ion approaches OH), and that there are no activation barriers.

Furthermore, the potential energy for the state in which, at the (001) plane of Pt_{ML}Ag, the produced H₂O is adsorbed on the catalytic surface was found, and adsorption energy was calculated. As a result, it was found that, at the (001) plane of Pt_{ML}Ag, also in the process in which the produced H₂O is desorbed from the catalytic surface, the activation barrier in the overall reaction is so small that it can be ignored.

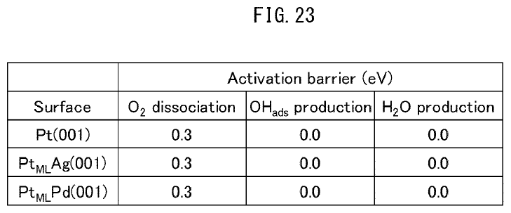

FIG. 23 is a chart showing the magnitudes of activation barriers in the oxygen dissociation process, the OH formation process, and the H₂O formation process at the (001) planes of the catalysts Pt, Pt_{ML}Ag, and Pt_{ML}Pd.

As shown in FIG. 23, in the process in which an oxygen molecule is dissociated and adsorbed in the form of oxygen atoms on a catalytic surface, the (001) plane of Pt_{ML}Ag has a similar degree of activation barrier to the (001) plane of the catalyst Pt. After the oxygen molecule is dissociated and adsorbed on the catalytic surface, at each of the (001) planes of the catalysts Pt and Pt_{ML}Ag, the OH formation process and the H₂O formation process proceed without activation barriers. The OH formation process takes place at each of the dissociated oxygen atoms; therefore, the evaluations were carried out on the OH formation when only one of the oxygen atoms is protonated and on the second one of the OH formations when both oxygen atoms are protonated. As a result, it was confirmed that, in each of the OH formation processes, no activation barriers are present. It was also found that, also in the process in which the produced H₂O is desorbed from the catalytic surface, no activation barriers are present.

Simulations were carried out also in regard to the (001) plane of Pt_{ML}Pd, and similar results to those described above were obtained.

Since the nearest-neighbor interatomic distance in the (111) plane and the nearest-neighbor interatomic distance in the (001) plane of a face centered cubic lattice are equal to each other, the same comments as described earlier in regard to the (111) plane in the [2.5. Pt—Pt interatomic distance and state density] section also apply to the (001) plane.

(4. Advantages of Core-Shell Catalyst in Accordance with the Present Embodiment)

As has been described, it was found that, according to the core-shell catalyst in one embodiment of the present invention, the dissociative adsorption step is dominant in the oxygen reduction reaction, and that there is an activation barrier in the process of dissociative adsorption of oxygen molecules but there are no activation barriers in the subsequent processes. As such, the process of dissociative adsorption of oxygen molecules serves as a rate-determining step.

It was also found that the activation barrier in the process of dissociative adsorption of oxygen molecules at the (111) planes of Pt_{ML}Pd and Pt_{ML}Ag is substantially equal in magnitude to that at the (111) plane of the catalyst Pt. This indicates that the (111) planes of Pt_{ML}Pd and Pt_{ML}Ag have the same level of catalytic activity as that of the (111) plane of Pt. It was further found that also the (001) planes of Pt_{ML}Pd and Pt_{ML}Ag have the same level of catalytic activity as that of the (001) plane of Pt.

This is attributed to the following: (i) regarding state densities at the catalytic surface, state densities in 5d orbitals are deviated to the higher-energy side as compared to Pt alone and (ii) the nearest neighbor Pt—Pt interatomic distance in the (111) plane or (001) plane of Pt_{ML}Ag is 2.81 \acute{Å} to 2.95 \acute{Å} and the nearest neighbor Pt—Pt interatomic distance in the (111) plane or (001) plane of Pt_{ML}Pd is 2.783 \acute{Å} to 2.81 \acute{Å}. Because of these, the bonding strength between oxygen atoms and Pt is optimized, and no energy barriers appear in the H₂O formation/desorption reaction.

Furthermore, in a core-shell catalyst particle, such (111) plane and (001) plane can be present dominantly.

Therefore, the core-shell catalyst, in one embodiment of the present invention, is capable of serving as a replacement for a catalyst particle made of platinum alone and capable of being used in an oxygen reduction reaction, and is capable of reducing the amount of platinum used.

Furthermore, Ag and Pd, each of which is for use as a core material, are highly electrochemically stable and less expensive than platinum; therefore, the use of Ag or Pd as a core material makes it possible to improve catalytic activity assuming equal material costs.

Thus, it is possible to provide a catalyst having a core-shell structure (which employs a core made of a highly electrochemically stable, relatively inexpensive material and thereby reduces the amount of platinum used, while providing a better cost/performance ratio in catalytic activity as compared to when a platinum particle is used as a catalyst) for use in an oxygen reduction reaction (cathode reaction of a fuel cell). It is also possible to provide an oxygen reduction method using the catalyst.

As has been described, a core-shell catalyst in accordance with an embodiment of the present invention is a core-shell catalyst for use for an oxygen reduction reaction, including: a core that contains silver; and a shell layer that contains platinum, the shell layer being comprised of a plurality of platinum atoms constituting a (111) plane of or a (001) plane of a face centered cubic lattice, in the shell layer, a nearest neighbor platinum-platinum interatomic distance falling within the range of from 2.81 \acute{Å} to 2.95 \acute{Å}.

A core-shell catalyst in accordance with an embodiment of the present invention is a core-shell catalyst for use for an oxygen reduction reaction, including: a core that contains palladium; and a shell layer that contains platinum, the shell layer being comprised of a plurality of platinum atoms constituting a (111) plane of or a (001) plane of a face centered cubic lattice, in the shell layer, a nearest neighbor platinum-platinum interatomic distance falling within the range of from 2.783 \acute{Å} to 2.81 \acute{Å}.

It is preferable that the shell layer is constituted by one to three atomic layers.

An oxygen reduction method in accordance with an embodiment of the present invention is an oxygen reduction method including using the core-shell catalyst as described above, the method including the steps of: allowing an oxygen molecule to dissociate into oxygen atoms and to be adsorbed on the (111) plane or the (001) plane; allowing the oxygen atoms adsorbed on the (111) plane or the (001) plane to react with protons to form a water molecule; and allowing the water molecule to be desorbed from the (111) plane or the (001) plane.

The present invention is not limited to the embodiments, but can be altered by a skilled person in the art within the scope of the claims. The present invention also encompasses, in its technical scope, any embodiment derived by combining technical means disclosed in differing embodiments.

### INDUSTRIAL APPLICABILITY

An embodiment of the present invention can be suitably used for a catalyst for an oxygen reduction reaction, especially for a cathode electrode catalyst of a fuel cell.

1. A core-shell catalyst for use for an oxygen reduction reaction, comprising:
a core that comprises silver; and
a shell layer that comprises platinum, wherein
at an interface between the core and the shell layer, silver atoms in an outermost layer of the core constitute a (111) plane of a face centered cubic lattice,
a plurality of platinum atoms that constitute the shell layer constitute a (111) plane of a face centered cubic lattice, the (111) plane constituted by the plurality of platinum atoms residing on the (111) plane constituted by the silver atoms, and
in the shell layer, a nearest neighbor platinum-platinum interatomic distance falls within the range of from 2.81 \acute{Å} to 2.95 \acute{Å}.

2. (canceled)

3. A core-shell catalyst for use for an oxygen reduction reaction, comprising:
a core that comprises silver; and
a shell layer that comprises platinum, wherein
at an interface between the core and the shell layer, silver atoms in an outermost layer of the core constitute a (001) plane of a face centered cubic lattice,
a plurality of platinum atoms that constitute the shell layer constitute a (001) plane of a face centered cubic lattice, the (001) plane constituted by the plurality of platinum atoms residing on the (001) plane constituted by the silver atoms,
in the shell layer, a nearest neighbor platinum-platinum interatomic distance falls within the range of from 2.81 \acute{Å} to 2.95 \acute{Å}.

4. The core-shell catalyst as set forth in claim 1, wherein the shell layer is constituted by one to three atomic layers.

5. An oxygen reduction method comprising using the core-shell catalyst as set forth in claim 1, the method comprising the steps of:
allowing an oxygen molecule to dissociate into oxygen atoms and to be adsorbed on the (111) plane or the (001) plane;
allowing the oxygen atoms adsorbed on the (111) plane or the (001) plane to react with protons to form a water molecule; and
allowing the water molecule to be desorbed from the (111) plane or the (001) plane.

6. An oxygen reduction method comprising using the core-shell catalyst as set forth in claim 4, the method comprising the steps of:
allowing an oxygen molecule to dissociate into oxygen atoms and to be adsorbed on the (111) plane or the (001) plane;
allowing the oxygen atoms adsorbed on the (111) plane or the (001) plane to react with protons to form a water molecule; and
allowing the water molecule to be desorbed from the (111) plane or the (001) plane.

7. The core-shell catalyst as set forth in claim 3, wherein the shell layer is constituted by one to three atomic layers.

8. An oxygen reduction method comprising using the core-shell catalyst as set forth in claim 3, the method comprising the steps of:
allowing an oxygen molecule to dissociate into oxygen atoms and to be adsorbed on the (111) plane or the (001) plane;
allowing the oxygen atoms adsorbed on the (111) plane or the (001) plane to react with protons to form a water molecule; and
allowing the water molecule to be desorbed from the (111) plane or the (001) plane.

9. An oxygen reduction method comprising using the core-shell catalyst as set forth in claim 7, the method comprising the steps of:
allowing an oxygen molecule to dissociate into oxygen atoms and to be adsorbed on the (111) plane or the (001) plane;
allowing the oxygen atoms adsorbed on the (111) plane or the (001) plane to react with protons to form a water molecule; and
allowing the water molecule to be desorbed from the (111) plane or the (001) plane.
